(19) United States
(12) Patent Application Publication
(10) Pub. No.: US 2008/0222166 A1
(43) Pub. Date: Sep. 11, 2008

(54) Data and file management system

(76) Inventors: Tomas Hultgren, Gothenburg (SE); Erik Nilsson, Gothenburg (SE); Johan Steen, Gothenburg (SE)

Correspondence Address: HARNESS, DICKEY & PIERCE, P.L.C., P.O. BOX 8910, RESTON, VA, 20195, US

(21) Appl. No.: 11/656,464

(22) Filed: Jan. 23, 2007

Related U.S. Application Data
(63) Continuation of application No. PCT/SE2005/001114, filed on Jul. 4, 2005.

(30) Foreign Application Priority Data
Jul. 3, 2004 (SE) 00401737-2
Jun. 17, 2005 (SE) PCT/SE2005/000940

(51) Int. Cl. G06F 17/30

(52) U.S. Cl. 707/100; 707/E17.005

(57) ABSTRACT

A data or file management system, communicating with a database directly or via a network interface, using a tree structured interface with simultaneous navigation within a tree branched map and display of content in a first, map, and second, content, window, respectively. Filter or sorting functions may be applied between the tree structured map interface and the content interface. Data found relating to downstream areas of interest in the tree branched map are all analyzed and indicated in the second window holding the content interface.

### FIELD OF THE INVENTION

The present invention relates to a data or file management system in general and in particular to a method of analyzing stored information in a multi view display of folder maps and content.

### BACKGROUND OF THE INVENTION

The overall trends in information based business structures are the need of quick and accurate information retrieval, a concern of finding the right and most suitable resources, and the availability of vast databases or information banks. For this reason solutions and business ideas has been established for sifting through large databases, for instance on the Internet, such as database search solutions, project advertisements, and job advertisements. These types of services rely on some simple and fundamental technical solutions emanating from simple database relationship programming: keyword searching or simple indexing of entries in these databases. However, in this trend some fundamental aspects of searching has been lost, such as cross connections, synergy effects, and knowledge based connections.

In for instance the search business Google or other similar Internet search tools, the services rely on the user's exact keyword match and knowledge of the subject. The user may need to spend several hours in search before actually penetrating a subject deep enough before starting to find the right “hits” of data, especially if the user is not familiar with the subject prior to starting a search.

In another example of manual searching in an ordinary encyclopedia, there are often synergy effects coming from the fact that when you do the search, other words completely different from your predetermined search will be seen and thus it is possible to get some kind of cross connectivity. However, this type of cross connectivity is not that useful since the found synergy data often are not that relevant, though they may be fun.

Searching in an indexing system, such as the indexing systems found for patent documents, wherein one searches through different categories of subjects with an increasing detailing concerning the subjects until one founds an appropriate index that can be used in an actual search of patent documents. This type of search do require a good understanding of the subject one is searching of and cross correlation effects are also quite low due to the detailing needed for the vast amounts of data available.

The same problematic discussions are present in areas such as match making of resources, for instance if a company are working on a specific project and needs to find a resource, e.g. a measurement service or equipment, a skilled person, or similar resources, the search is often done locally within the normal network of contacts or equipment resource centers or a blind search may be done using the available normal search tools found in the Internet or through expensive information specialists or brokers.

As the number of files stored in computer systems or network system increases dramatically, the need of keeping track and finding individual files in a simple and intuitive manner increases.

It is the object of the present invention to remedy some of these concerns and to present some new aspects to searching and analyzing data.

### SUMMARY OF THE INVENTION

The present invention provides a new search tool and system enabling new possibilities by providing cross connections and larger amounts of relevant results and hits. This may be accomplished by a new systematization of areas of interest, topics and applications and a systematization of relations between these two parts.

This can be accomplished in several aspects of the present invention, where a first aspect, a file or data management system is provided, comprising:

a file or data system database with searchable entries;
a file or data manager communicating with the database and
wherein the file or data manager comprises processing arrangement for organizing search results in a structure comprising two presentations; a first presentation for organizing selectable folders in a map with a tree structure with general levels of folders upstream and more detailed levels of folders downstream, and a second presentation for simultaneously organizing database entries associated with folders in downstream connection with a selected folder from the first presentation.

The arrangement of organizing database entries may comprise organizing a summary of each entry found in the second presentation, each entry found in its entirety, or only a title of each entry found in the second presentation.

The processing arrangement may be arranged to apply a filter operating on database entries associated with the folders in downstream connection with the selected folder from the first presentation when organizing associated entries in the second presentation.

The filter may be arranged to filter on at least one of name (e.g. alphabetically), date (e.g. of creation or last changed), type (e.g. documents, run files, system files), owner of file, ranked importance, size, location, number of users, creator of file, keyword, version, content, category, and number times file has been used.

The folders may be grouped into comprehensive groupings comprising parts of or a hole map.

A plurality of maps of different criteria can be used for comparing quality aspects between the different criteria, such as comparing graphically at least one of size, complexity, or symmetry aspects.

The map with tree structure may be a tree structure in one, two, or three dimensions.

The selected folder is centered in the first presentation when selected and the rest of the map is rearranged accordingly.

Yet another aspect of the present invention, an instruction set stored on a storage medium providing search results from a file or data management system is provided, comprising

an instruction set for sorting database entries in a tree structure of folders in a first presentation;
an instruction set for selecting a folder in the first presentation;
an instruction set for presenting in a second presentation database entries associated with folders in downstream connection with a selected folder from the first presentation.

The instruction set may further comprise an instruction set for filtering the database entries using filtering parameters.

The filtering parameters may be at least one of name (e.g. alphabetically), date (e.g. of creation or last changed), type (e.g. documents, run files, system files), owner of file, ranked importance, size, location, number of users, creator of file, keyword, version, content, category, and number times file has been used.

The instruction set may further comprise an instruction set for centering the selected folder in the first presentation when selected and an instruction set for rearranging the rest of the map accordingly.

Yet another aspect of the present invention, a network for data management is provided, providing redundancy and security protection, comprising a plurality of processing units each comprising processing arrangement for organizing search results from a database in a structure comprising two presentations; a first presentation for organizing selectable areas of interest in a map with a tree structure with general levels of interest upstream and more detailed levels of interest downstream, and a second presentation for simultaneously organizing database entries associated with areas of interest in downstream connection with a selected area of interest from the first presentation.

Still another aspect of the present invention, a database object stored on a storage medium is provided, comprising:

an information object;
a list of area of interest which the information object is relevant to; and
a list of applications which the information object is relevant to,
wherein the database object is arranged so search results from the database is presented in a structure comprising two presentations; a first presentation for organizing selectable areas of interest in a map with a tree structure with general levels of interest upstream and more detailed levels of interest downstream, and a second presentation for simultaneously organizing the information objects associated with areas of interest in downstream connection with a selected area of interest from the first presentation.

Another aspect of the present invention, a business method for providing decision making services within project management, wherein the data management system as discussed above is used for comparing regions with each other, the method comprises the steps of: analyzing available resources within a plurality of regions with the data management system; comparing the regions with each other using comparison criteria; and providing a recommendation of best suited region for a specific project.

The regions may be geographical regions or departmental regions.

The comparison criteria may be at least one of quality, population, companies, geographical areas, type of equipment, cost, keywords, language, value, relevance, rating, track record, capacity for realization, customers, funding, size, educational level, number of employees, publications, certifications, branches, patents, and markets

The invention has one advantage in that it provides a quick examination and overview of all database entries within a certain branch and therefore provides an efficient tool for decision making and finding relevant data.

These and other aspects of the invention will be apparent from and elucidated with reference to the embodiments described hereinafter.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates schematically a data or file management system according to the present invention;

FIG. 2 illustrates schematically a tree structure and content field according to the present invention;

FIG. 3 illustrates schematically an edit interface system according to the present invention;

FIG. 4 illustrates schematically a benchmarking view according to the present invention;

FIG. 5 illustrates schematically a content widening concept according to the present invention;

FIG. 6 illustrates schematically a network according to the present invention;

FIG. 7 is a schematic of a method when an administrator requests to update information;

FIG. 8 is a schematic of a method when a client request information;

FIG. 9 is a schematic illustration of part of a network according to the present invention; and

FIG. 10 is a schematic illustration of a larger part of a network according to the present invention;

### DETAILED DESCRIPTION OF THE INVENTION

In order to increase the effectiveness of a data management database the present invention interacts with database infrastructure components in order to cross link information and display information in a novel and efficient way using maps with branches of related objects (similar to tree branches). During a search the user navigates through a tree structure of areas of interest or thematic objects (i.e. objects with different topics), and where the tree structure shows sub areas of interest under each area of interest. If the user selects an area of interest all documents in the database about that area of interest and corresponding sub areas sorted in an increasing order of relevance of interest are shown in a separate field in a list containing at least part of the information in a quick view or thumbnail view. An embodiment of the present invention involving a file management system will be described later in this text.

Documents or data as understood in this invention may be almost any type of information and some examples will be discussed later for some specific application areas of the present invention. Documents may contain information of interest and resources relevant for this information, and often an owner can be identified in association to the information. Documents can be retrieved automatically and stored in the data management system according to search or retrieval criteria or the documents can be manually connected to the data management system. In the case of automatic retrieval the content of the documents can be indexed, sorted, marked or analyzed automatically according to set analysis criteria, and in the case of manual retrieval the content can be manually analyzed. Of course automatically retrieved documents can be manually analyzed and manually retrieved documents can be automatically analyzed.

The user is free to navigate around the tree structure in any way that is suitable or of interest which provide high flexibility and a high probability for synergy findings (almost as when searching in a dictionary or encyclopedia); however, in this database, information is arranged in a structure of related relevant areas and sub areas increasing the possibility of finding relevant material. The tree structure is not limited to any particular presentation layout but can involve for instance a left to right manner, right to left, top to bottom, bottom to top, concentric, or any other similar manner.

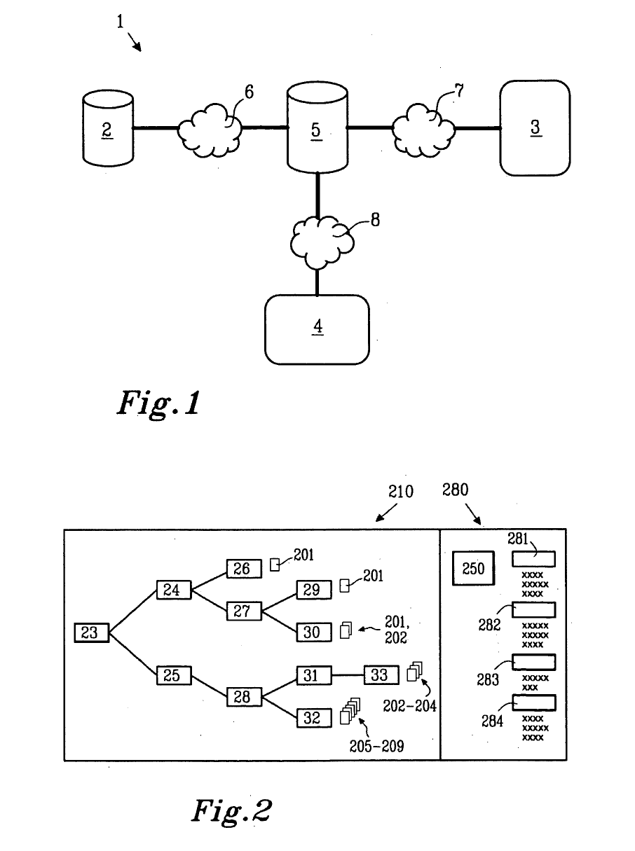

FIG. 1 illustrates a search system 1 according to the present invention and comprising a database unit 2 with stored information, an interface unit 3, display unit 4, and a processing unit 5. The processing unit receives commands from a user using the interface unit 3 and presents data and interface signals on the display unit 4. The processing unit 5 communicates with the database unit 2 for retrieving information and presenting results of searches. All components may communicate directly or indirectly on communication interfaces 6, 7, and 8.

The database unit 2 may be for instance a storage unit or a plurality of storage units (volatile or non volatile), e.g. hard disk, a RAID system, memory unit or units, CD (compact Disc), DVD (Digital Versatile Disc), or any other type of storage means located locally or distributed geographically as understood by the person skilled in the art.

Information is stored on the database unit 2 in a suitable database structure with cross references between documents with information about applications and areas of interest (thematic view). A document may be of interest in several areas of interest at the same time.

FIG. 2 illustrates a data management search interface according to the present invention. During a search the user navigate through a tree structure 210 (a navigation field or navigation map) comprising areas of interest categorized in different levels of detail and connected to each other where there are more detailed sub areas of interest. A top level area 23 (a general level of interest on the left in FIG. 2) is divided into several sub levels 24 and 25 which in turn are divided into even more detailed sub levels 26 to 28 (more detailed levels on the right in FIG. 2) in turn divided into even more detailed sub levels 29 to 32, and even further 33. When a user selects an area of interest, information contained in sub levels of that selection is presented simultaneously in a separate content interface 280 comprising a content field 280 and documents and/or information 281 to 284 stored for these area or areas of interest in this content field 280. For instance, using FIG. 2, if a user selects the area of interest within box 24 all information stored for the objects 26 and 27 (and in combined sub levels) will be presented in the content field 280. In this content field 280, results may be for instance represented as complete information, as process or application areas which can be expanded so as to reveal a list of documents, as summary information, or as thumbnails depending on type of information, type of search, or amount of information. Information and documents are preferably only available for “bottom” end areas (i.e. in FIG. 2 rightmost objects) within the tree structure, i.e. the most relevant and detailed level within each branch. All other area fields only contain connections to other areas of interest. However, when the same content information is available for all sub areas of a chosen area of interest, the content is connected to the chosen area instead since it is marked as a more general resource or document. Using a certain filter setting it may be viewed in connection to a non-“bottom” area. More about filters will be discussed below in this document. Let us look at FIG. 2 again. Document 201 belongs to several areas of interest 26, 29 and 30, this means that the document 201 is of general interest to a higher area of interest (in this case area 24) and will be connected to this area instead of each end of sub branches under this higher area of interest 24. It should be noted that in other applications the documents or information may be available at other levels of the tree structure.

In the content interface 280 more information 250 may be shown, such as, statistical functions, administrational data (e.g. last update, administrator, storage location, and so on), summarized information of any documents that may have been selected within the content field, and any other information relevant for the found documents. In order to facilitate cross linking between area of interests and possible applications within the area of interest, when an entry is selected from the list in the content field, a list of in which application areas that entry is relevant will be presented also within the content field. The user may then switch to an application tree structure relating different applications with each other and see other applications where the same entry may have relevance to.

If an entry in the content interface is selected, the associated areas of interest are marked in the navigation map. Just as in the case above where application areas can be provided within the content field for a certain entry, a list of all area of interest where the entry is relevant for may be provided within the content field.

If an entry (e.g. a document) in the content interface is opened it may be opened in a separate interface.

The areas of interest can be named preferably with a text that resembles the content within the area of interest. Thus it is easy for the user to navigate to more detailed levels and understand what type of information that is contained within each area or associated in sub levels within each tree branch.

When selecting an area of interest in a tree branch this area of interest may be moved to a central position on the display unit and all other areas of interest will also then be moved accordingly to keep their respective relative positions, this to ensure that the chosen area of interest is presented within a suitable context, i.e. with other areas if interest relevant to the chosen area are presented locally and thus easily accessible with the management interface.

The number of areas of interest, the number of levels of detail in the tree structure, and the amount and number of resulting documents or information in the result field is not limited to the number shown in FIG. 2, but may comprise in theory an infinite amount, but is of course in practice limited to a suitable number and amount in order to find data and store data physically within data storage devices. It is possible to restrict the number of shown documents in the content field 280 by filtering results with different filtering functions, such as include or exclude certain companies, quality, geographical areas, type of equipment, cost, contact details, keywords, language, value, relevance, rating, track record, capacity for realization, customers, funding, size, educational level, number of employees, publications, certifications, branches, patents, markets, and so on. The total number of areas of interest may for instance be in the order of up to some ten thousands and the number of levels may in the normal case be in the order of ten to twenty. However, the number of levels may be smaller or larger depending on search area. Also, due to the possibly large amount of branches and sub levels these maps may be larger than can be displayed simultaneously on a monitor or similar while at the same time being readable. The system is therefore provided with a centering function, where a selected object with the branch is centered in the view field when selected, sub levels to the selected object is revealed if they were not viewable before. The selected object is marked so as to provide the user with a clear image of what has been selected. Also if an information object within the content field is marked, the objects relation to the map field will be marked.

It is possible to simplify the tree structure, for instance with many sub levels present one may collapse a chosen number of sub levels into one area and documents associated with the collapsed tree branches will be then be associated with the remaining area.

The areas of interest may in turn be divided into groups of interest, for instance a database about physics may be divided into separate sub areas of interest such as optics, material science, electronics, and so on. When navigating within the physics area of interest navigation need only be done within a certain sub area of interest and the other areas need not be shown. It is possible to have a separate view where the user may choose an appropriate sub area grouping and when the selection is done this grouping is opened in the normal navigation field. These groupings can be looked upon as shortcuts, where a small tree structure map with condensed complexity contains a number of levels of detailed information, and selecting an object within this condensed map a map with detailed information associated with the selection is provided. Another way of using the grouping function is to merely present a plurality of objects not associated with each other but maybe within the same general common area of interest; selecting on of these objects will open a map within this area of interest.

An information object (e.g. a document) within the data management system comprises three parts:
1. The actual information such as a document for instance.
2. A list of area of interest where the information is relevant, i.e. where in the map of area of interest the document should be associated.
3. A list of application areas where the information object is relevant.

These three parts may be cross referenced in order to link area of interests and application areas with each other. This will give the user a possibility to search neighboring fields of interest and/or application areas in order to benefit from synergetic effects. The list of application areas where the information object is relevant can be built up into a tree structured map and the relative position (or positions) of the information object is stored. The information objects associated areas of interest is also stored. By selecting the information object in a tree map of applications areas the user is switched to a tree map with areas of interest, where it is possible to navigate to similar or neighboring areas of interest and possible get the synergetic effects mentioned above.

Setup of the data management system according to the present invention may be described as follows:
1. Applications of (or processes associated with) areas of interest are selected and an application map is built up of selected applications connected in the tree structure as described above with general application areas and with associated sub areas of applications. This can be done by selecting applications from a predetermined set of available applications with for instance a drag and drop function.
2. Documents are sorted according to relevant applications and with areas of interest. Thus a connection is established between applications and areas of interest.

Use of the data management system according to the present invention may be described as follows:
1. A user examines the content of a process or application map, where the content field includes areas of interest provided in sub branches of the selected area of interest and documents associated with these areas of interest.
2. The system identifies all documents marked as relevant to the chosen application.
3. The system displays all applications where these documents are associated with.
4. The content field of the system shows areas of interest that has been identified in the documents as relevant for the application and at the same time the system can display all other documents associated with the shown areas of interest.
5. If an area of interest is selected in the content field the system switches to the area of interest map with the selected area of interest centered on in the map field. From this it is easy to widen a search to other related areas of interest.

As discussed above, the data management concept according to the present invention include two different views or presentations on information: a first view using the above discussed areas of interest concept and a second view concerns processes or applications cross referenced with the above areas of interest. Each view is divided into two fields: a map with tree structure and a content field.

The user may himself define a map of application areas associated with a document, by selecting applications from a hierarchical structure of more detailed levels. This is advantageous since then it is possible to reduce the size of the maps to a more comprehensible size more in relevance to the user's own field of interest and application areas. Application entries are associated with documents within the database and these documents are associated in turn to areas of interest (or topics).

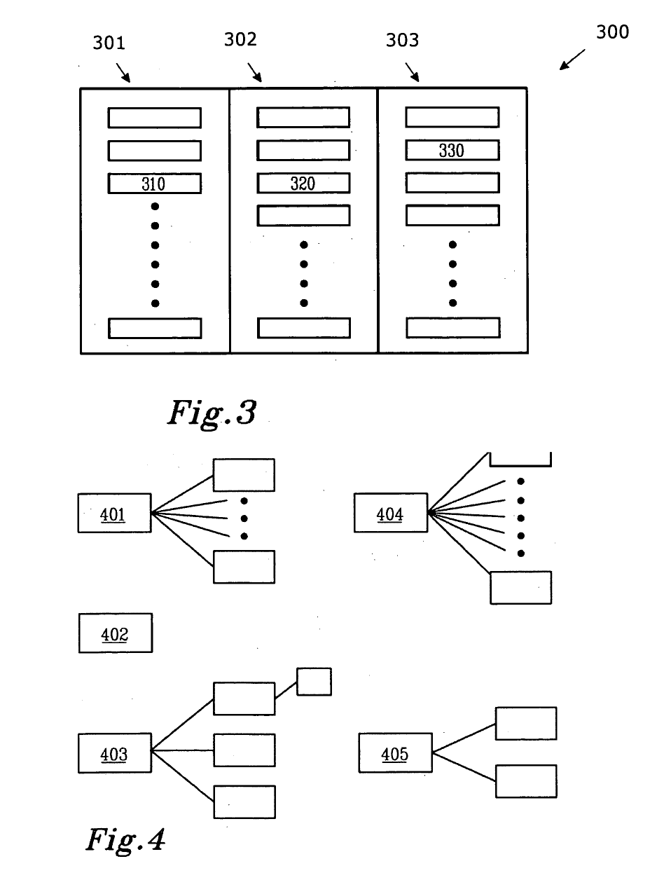

The second view or presentation is also a tree structure but, whereas the tree structure of the first view is predetermined, the second view may be either predetermined for a specific application area or built dynamically by a user of the management system. Such an interface 300 for building an application map is shown in FIG. 3. This interface may be used in for instance building a tree structure of the second view, wherein application areas are collected in another tree structure. Three fields are used for determining relevant processes (or applications) where in FIG. 3 the leftmost field 301 is a more general field and to the right more detailed fields are shown. A user selects an object (application) 310 from the leftmost field 301 and the system updates the middle field 302 with sub applications associated with this selected more general object 310. The user may then select an object 320 from this middle field 302 and the system then updates the rightmost field 303 with sub applications associated with the chosen middle application 320. The system may center objects selected in the display field so as to provide a convenient number of relevant objects to the selected object. The user may select an object 330 from the most detailed list 303 which will be incorporated into the tree branched structure. The number of levels are not restricted to three (the number may be smaller or larger as well) or the graphical layout of the selection interface. In this view documents may be associated to any level within the tree branch. When associating a document to a particular application it is possible to rate how important the document is for the particular application using a quality scale. It is later possible to in both the area of interest map and the application map filter results into the content field using this quality rating parameter.

Filters can also be applied in this second view between the tree branched application map and the content field.

In order to include new documents and information in the database it is advantages to have a suitable interface for editing and amending information data. If adding a document to an object within the database (by for instance drag and drop) it will automatically be associated to the selected area. If the document is associated with an object not at the end of the tree structure but to an object higher in the tree structure, the document will automatically be associated to all levels below that selected.

The system may be provided with a benchmarking or statistics function, where it is possible to compare different groupings with other using selected criteria, e.g. capacity of realization of different regions with each other. This can be done in a graphical way as schematically shown in FIG. 4, where several groups of a particular area of interest 401 to 405 are shown for e.g. different geographical areas. By comparing the size and number of levels of detail for each group it may be possible to get a quick view of quality aspects of the selected groupings. For instance, within an area of interest of physics with sub grouping optics it is possible to compare different geographical areas (e.g. Sweden, England, USA, Denmark, and Germany). Sub areas of interest are shown for each geographical area and the number of sub areas indicates for instance available resources and quality within each geographical area. Thus the geometrical shape, complexity, symmetry, and size of the branch structures may provide help in decision making using such a benchmarking tool/function. To facilitate this benchmarking function it is preferred that all maps compared use the same basic structure and that the same areas of interest are organized in the same relative position to each other; this to ensure that an analysis is based on similar structures, since this is a graphical analysis. Decision making can be of interest in for instance deciding upon where to start a new development project or where to start production, e.g. in-house within a company or comparing geographical regions and their respective possibilities of providing successful environments for solving problems and providing competent services, people, and funding.

Benchmarking and/or statistical information may also be provided within the content field presented graphically or in text form. It is also possible to control the presentation of a grouping by changing the apparent size in accordance with number of documents or similar within each group of area of interest.

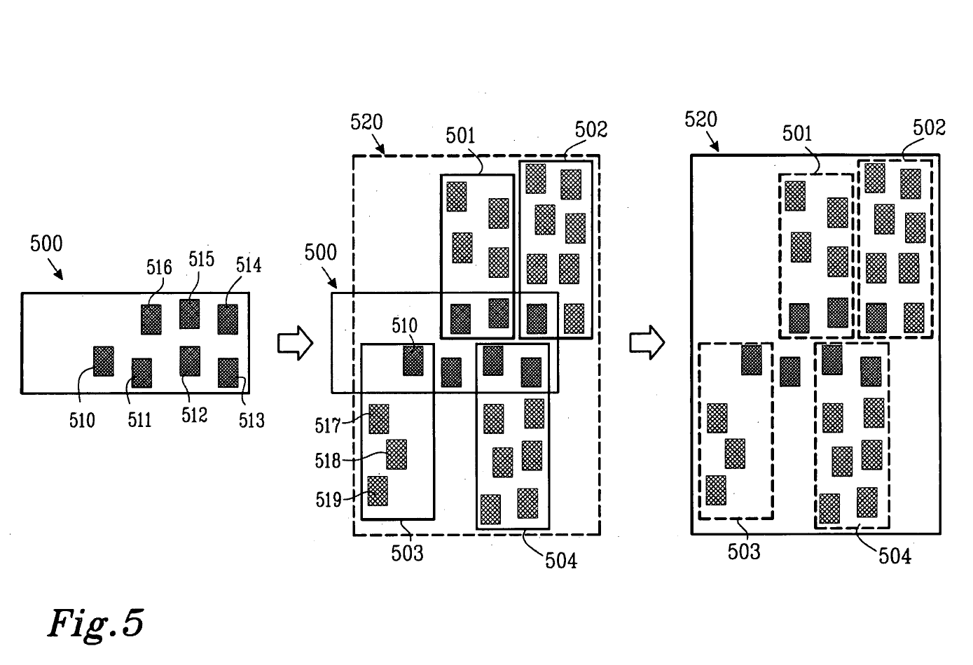

FIG. 5 illustrates how synergetic effects may be achieved from the data management according to the present invention. A number of documents 510 to 516 have been found relevant to a search within an application area 500. However, since these documents belong to areas of interest (e.g. resource areas as will be discussed below) it is possible to expand the search content to include areas of interest 501 to 504 where there is at least one document from the specific first application area 500. For instance let us follow a document 510 from the first application area 500. This document 510 also belongs to an area of interest 503 which has a number of documents 517 to 519 which did not belong to the first application area 500. However, these new documents 517 to 519 may be included in an expanded application area 520. The total of documents in the expanded application area 520 may give information about resources applications or available resources which would not have been found in a normal search profile.

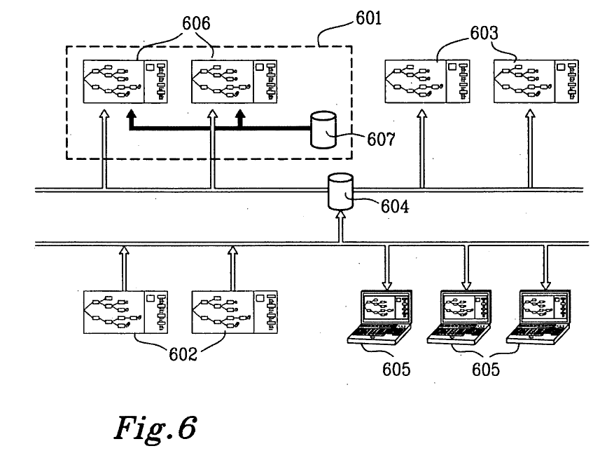

The present invention may be utilized in an embodiment for finding suitable resources for a project by searching a database comprising information about available resources in a region, within an organization, or within an area of interest. Such an embodiment is shown in FIG. 6 illustrating a network topology. The resource management system may operate from at least three different interface modules, within a corporate network 601, a web interface using web servers 602, and a standalone client interface 603. A server gateway 604 may be provided for communicating with web interfaced servers 602 on a private or public network (e.g. Internet). Standalone client systems 605 (e.g. personal computers, laptops, or similar) can communicate directly with the web server or servers but corporate interface systems 606 may communicate using the server gateway 604. Corporate systems 606 may also communicate with an internal data management server 607.

This is done by increasing the solution amount for different properties within a given product through the new systematization of resources and applications and systematization of relationships between resources and applications. The project may be a product development project wherein resources are needed in order to complete the development project; these resources may be for instance people or equipment.

In order for the search system to operate, a system for objective resource identification is needed, a search and mapping function identifies the most relevant resources for a given specification. The system identifies all relevant resources from which the user may choose one or several selections from to examine in more detail.

A search tool is provided that comprise a graphical interface with the tree like structure in order to provide identification of resources. The first view shows a resource map and selecting a resource object in the map will result in a list of associated resources where there is a resource description in sub branches of the current branch displayed in the content field. The user may then switch to a competence map (area of interest) and see in which other areas the found resource is relevant for, thus getting a wider result from his search. Due to the structure of the mapping function, the relevance of the resulting widened result will be increased as compared to normal index (keyword) searches.

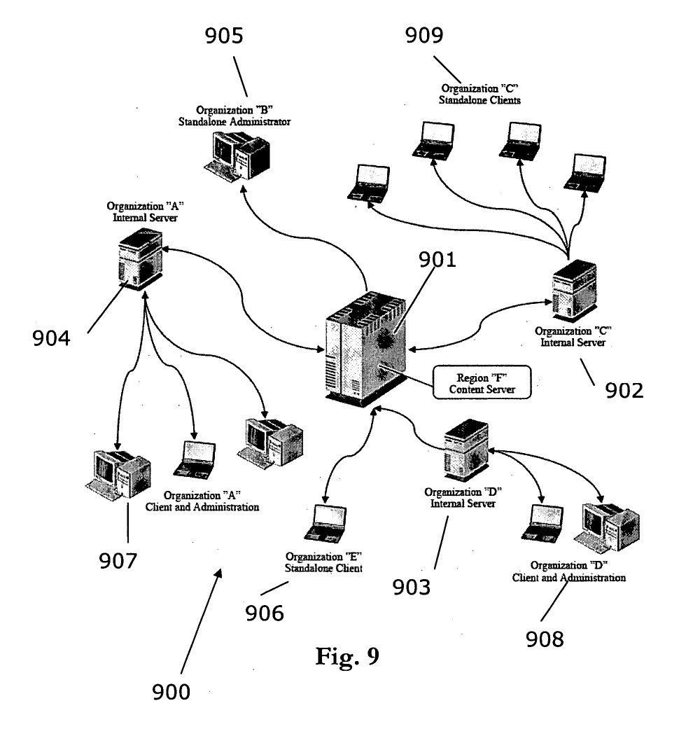

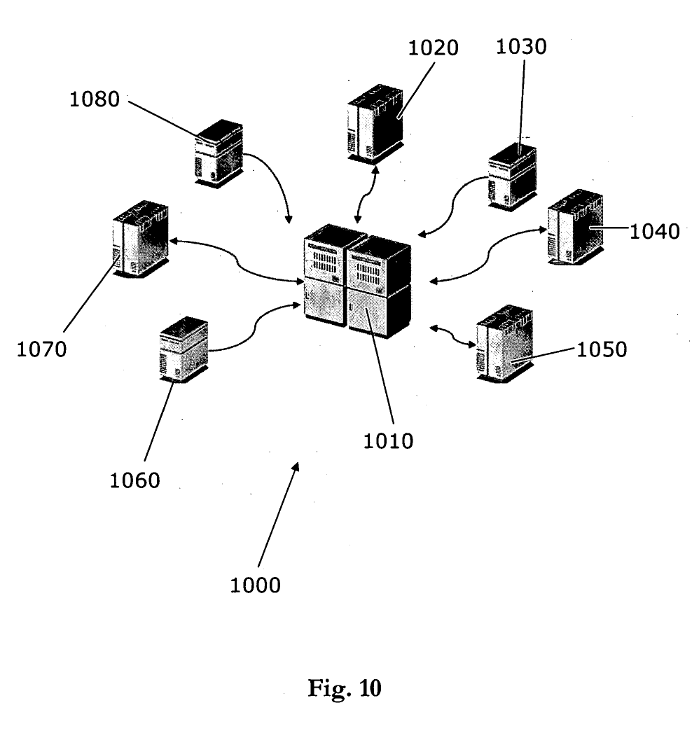

A network solution is provided for keeping records up to date within the data management system and this will be described now referring to FIGS. 9 and 10:

This is a method for keeping the content of a global net of servers in corporate levels 902 to 905 and 1030, 1060, and 1080, regional levels 1020, 1040, 1050, 1070, and 901, and a main content server cluster level 1010 synchronized and organized in a global hierarchy against a real time client 906 to 909 and web environment to prevent logical errors in the content while at the same time being able to manage a large number of simultaneous connections. To keep all users' graphical user interface to the system updated automatically on a demand basis to the latest iteration of the content. This is a solution to several problems that would occur and could prevent a system graphical front end for a database used widely on a global level to be able to work as bandwidth efficient, secure and stable as the data management system require and do with this communication solution.

Communication between components in the network is performed with the help of XML language with a structure designed for this purpose, in this instance from local client application to server or server to server over an encrypted internet connection and is processed on the server level with custom developed server solutions developed with the server side language Python, as used in this particular instance for this unique solution which are able to efficiently handle the speed and amount of data an application of this scale needs, but the principle can be applied to any suitable language other than the ones mentioned.

This method is developed with the mindset to serve the needs of the data management system with its unique way to graphically interface data to the user. But will be applicable to be used in many other situations as well that will have the need for this kind of efficient updating system with instant feedback to the clients.

This architecture of the server system will keep the bandwidth down as much as possible as the main usage of the system will be receiving information and not sending information, and with that consideration most of the content requests will come from the closest server to the client and not put unnecessary load on the main content server.

Also, this provides system stability as if one server goes down for any reason or maintenance the clients of the affecting server will automatically get transferred to another region server while the affected server is getting up and running again. The main content server is a clustered system which can handle that parts of it is getting added or removed while operating without affecting availability.

A number of examples of situations will now be described in some detail. The first is a discussion about private versus public content.

A system like the data management system according to the present invention which contains lots of corporate sensitive data that needs a high security protection and that is solved by using layers in the global hierarchy with the last node of the server structure ending with a corporate internal server 902 to 904 located at the affected company server 902 to 905 and 1030, 1060, and 1080 or regional server 1020, 1040, 1050, 1070, and 901 if the clients 906 to 909 don't have the need for private (closest regional server) and provides the company clients with that information. The server also works like their own local regional server as it also stores and keeps all private content entered by the corporation's employees concerning the company's private processes, profiles and competences.

Three components are used within the system and with a fourth working in the background

### Web Server 1030, 1060, and 1080:

Communicates one way, by sending the information upstream. The Web server is a single client to present an organization or agency's competence resources on the web (their website). It doesn't retrieve anything from the data management system main database, but it provides all information entered by the organization in the client back to the data management system so it becomes distributed and available to all other clients and servers in the system using an access client.

### Access Client 906-909;

Communicates both ways, all public information entered into an access client is sent back into the network and made available to the rest of all clients connected to the data management system. The access client also retrieves all information from all organizations and companies in the network so they can be examined and benchmarked.

### Data Management Server 902-904;

Keeps track of the organizations private data entered into the data management system and makes it available to all clients in the organization that shall have access to it as well as a middle hand keeping a mirror of the main content database for faster and less bandwidth retrieval. The server can be configured in different capacities depending on the requirements for each and everyone (regional, organizations).

### Main Content Server 901, 1010;

This is the main content server cluster controlled centrally that keeps track of everything in the network and all clients and servers connected to it as well as having all information entered into the system stored in a complete always up to date record.

In some cases a company does not have their own internal server but instead relies on direct contact with a regional server 901 using a standalone administrator client 905.

The basic operation of the system according to the present invention will now be discussed:

The coordinating main content server cluster 1010 distributes and synchronizes all content between the regional servers 1020, 1040, 1050, and 1070. The internal servers get their public content distributed from the regional server 1020, 1040, 1050, and 1070 it is assigned to. The content versions get synchronized up and down through the hierarchy on demand. All content in the systems is marked when it was last modified which transport packages gets compared against when asking to change or receive information to prevent errors in synchronization.

If a parent server is down the current server or client asks the coordinating server cluster 1010 for an alternative route to make sure the network is always available and up and running. This way the content can always find a path between the client and the main cluster while keeping the bandwidth down as much as possible.

When client starts it establishes an encrypted connection over the TCP/IP protocol to transport the packages containing the information within the system. However, the invention is not limited to the TCP/IP protocol; other protocols may be used as understood by the person skilled in the art, such as UDP (User datagram protocol), FTP (file transfer protocol), SNMP (simple network management protocol), PPP (point-to-point protocol), DECnet, NetWare/IPX, AppleTalk, and OSI. Some of these protocols are part of the TCP/IP protocol standard.

When a connection has been initialized the session is in action to transfer the data back and forth over the encrypted internet connection. The current connected server builds all the information needed to create the visual graphics for the clients with a custom command scheme to be able to run the client on older machines without loss of performance.

The client let's the user make changes and when the user is finished the client sends a request to the server to store the changes. The changes get cued in the server application and the server executes the action when it has come to the requests turn.

When the regional servers, gets requests from clients it locks a session with data in question against the main cluster to make sure the data can't be updated from another regional server while the active one is performing its request. If there are other access requests to the same data, they will be added to a cue. Storing when the attempt was made, to be able to report back if there has been a change made while the first one was accessing the server. Then the next access gets the update before he is allowed to make changes.

The changes will not be visible for the client until the server has executed the request and reprocessed all its bindings. The actual area is also locked all over the network for further changes until the server is finished with the execution.

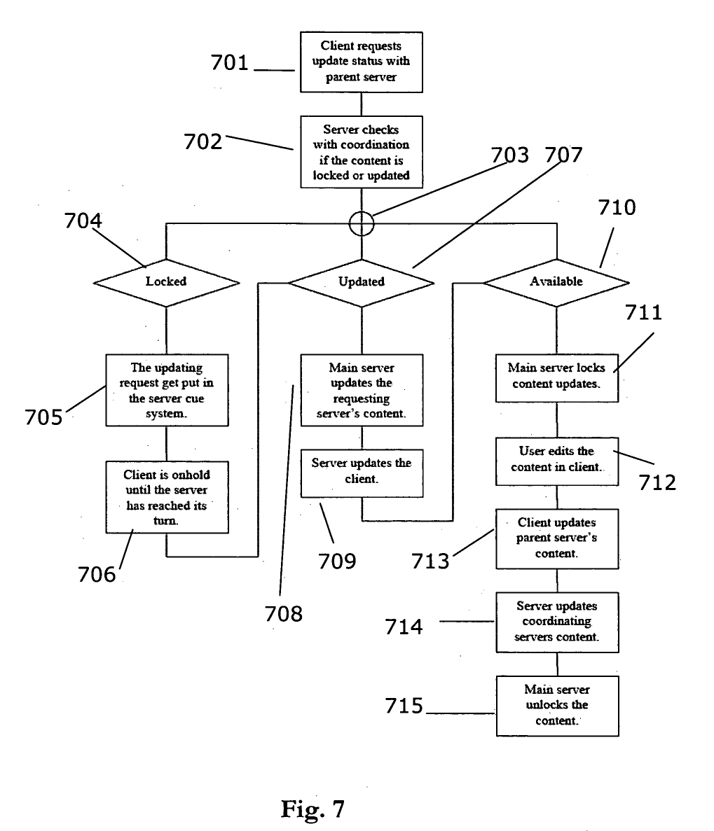

In the case of an administrator requests to update information, the procedure may be as follows with reference to FIG. 7:

To make this possible and secure the system is working through the following steps when a client requests to make a change in the content. (701) Client requests content status with the parent server. (702) The parent server passes on the request to the main content cluster which handles the coordination of the network to see if the content is already locked or have been updated since the client retrieved the original content. (703) Three things can happen here depending on if the content is locked (704), updated (707) or available (710).

### (704) Locked:

(705) The updating request gets put in the servers cue system awaiting its turn until prior update requests from other clients/servers has been handled. (706) The client is in an on hold state until the server has reached its turn and can handle the update request. And then moves onto (707).

### (707) Updated:

(708) The main server transmits the latest iteration since the previous updates in the cue back to the requesting server so the content database in the server gets updated. (709) The requesting server provides the updates down in the chain to the requesting client so the client has the new update before being able to make and transmit its new change to the content. And then moves onto (710).

### (710) Available:

(711) The main server locks the content in question for updates from other clients/servers and is ready to receive the new update.

(712) The user edits the content which was requested to get changed.

(713) The client transmits the updated information to the parent server.

(714) The parent server updates the main coordinating cluster with the new updating information so it gets available to the complete network.

(715) The main server unlocks the content for this editing session and makes it available again for further editing from other locations/clients.

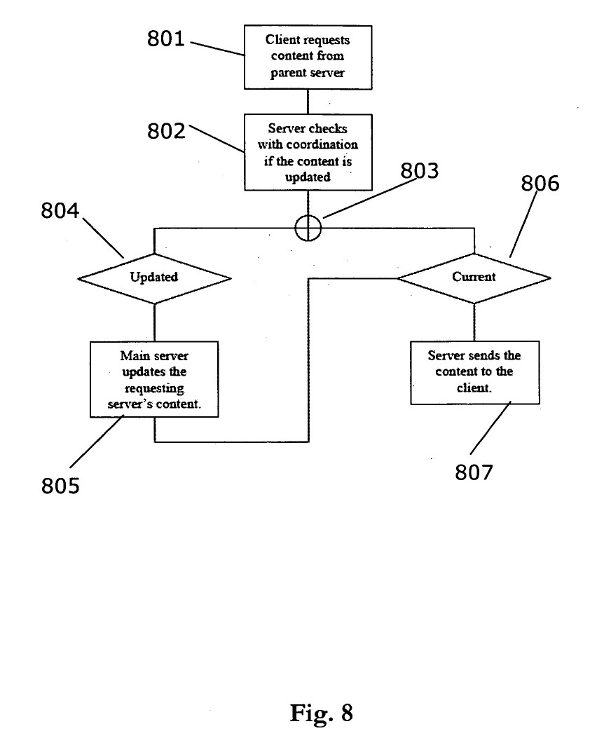

In the case of the client requests information, the procedure may be as follows with reference to FIG. 8:

To make sure the client always receives the latest iteration of the content when making a request and updating the affected servers on the way if needed the following steps are used.

(801) The client sends a request to the parent server for the relevant content.

(802) The server sends a request to the content server with its last update tag for the relevant content.

(803) Two things can happen here depending on if the content is updated (804) or current (806).

### (804) Updated:

(805) The main server cluster updates the requesting server's relevant content and then moves on to (806).

### (806) Current:

(807) The requested server sends the relevant current content to the requesting client so it can display the latest available version of the content for the user and on the same time have all servers on the path from the main content been updated during the process.

Using the data management system according to the present invention it is possible to provide services for deciding on where to locate new projects, such as development projects, production projects, or education projects, since the benchmarking functions within the system can provide comparisons between different regions (geographical or departmental) and their respective realization capacity.

The cross linking concept can be advantageous in other business areas such as in a procurement process which may be facilitated by the data management system according to the present invention by matching available procurement demands with available resources. Resource providers may search a database with available procurements and find procurement demands within areas not normally covered by the resource provider and vice versa procurement demanders may search database for resource providers and may find such within areas of interest not normally covered or known to them.

The database management system may also find applicability within file management as for instance in a file manager used in operating systems. Files are often allocated and saved in folders that may be contained within other folders and so on. This makes it sometimes difficult to find a specific file, especially if one does not know the exact name of the file or exact location of the file. Using the database management system according to the present invention a user can easily browse through a vast folder structure in the tree structured map layout 210. The tree structure is not limited to the screen or window size but can extend in all directions from the boundaries of the screen or window where the data is presented. By selecting a tree structure element (i.e. a folder, or file storage element (e.g. a disk, server, or distributed file storage unit (RAID—Redundant array of independent disks)), all files associated with that tree structure will be presented in the content window 280. The content in the content window 280 may be sorted or filtered according to user selectable criteria such as by name (e.g. alphabetically), date (of creation, last changed and so on), type (documents, run files, system files, and so on), owner of file, ranked importance (a user or system program may determine the importance of the file based on content, type of file, and history), size, location, number of users, creator of file, keyword, version, content, category, and number times file has been used. The sorting function can be extensive and above examples are only a sub set of possible sorting functions, as understood by the person skilled in the art. A filter may also be used to include or exclude certain folders or files according to above criteria, or for example certain types of files. The absence of files (entirely or of a certain type) in a folder may mean exclusion of that folder in the content window 280 and/or the trees structured map 210.

Since the user sees all the files within each selected branch it is easily found and the user will get a quick and good overview of the content in many folders at the same time or with a few selections. The user may navigate simply by pointing a navigation tool (e.g. a mouse) in a: certain direction of the map and the map will move the map accordingly to allow the user search in that direction or the user may use any other suitable interface tool (e.g. arrow buttons on a keyboard or any other keys of the keyboard) to navigate within the map. In such an application files (i.e. database entries) may of course be located at any level of the trees structure (i.e. folder level).

A short description 250 on a selected folder and/or file can be included in the content window 280. The content window 280 may also be arranged so as to sort results according to folders in order to see what folder a certain file belong to. This can be done for example by listing all files from a folder in a group, e.g. the folder as a heading and each file belonging to that folder underneath.

It is also possible to arrange database entries, e.g. files and folders, within groups of data which in turn may be each navigated separately using the file management system according to the present invention.

The file management system according to the present invention may be used in any graphical operating system, including, but not limited to, Microsoft Windows, Apple Mac OS, OS X, IBM OS/2, BeOS, UNIX X Windows, and Linux Gnome and KDE. The file management system may be used for any type of file system, including, but not limited to, FAT, HFS (Hierarchical File System), NTFS (New Technology File System), and so on as understood by the person skilled in the art. For all above mentioned examples of graphical environments and file systems the present invention can be used for any version or flavors (past, present, and future) of them, e.g. Linux has a vast number of different flavors of OS (operating System) and graphical user interfaces (GUI) available.

Generally, updating any processes, documents, or areas of interest will lead to updating of cross links as well.

The invention has been illustrated with 1 or 2 dimensional tree branches but can of course also be utilized with 3 dimensional structures (branches). Data can be organized in larger dimensions of course; however, no more than three dimensions of such a tree structure can be displayed simultaneously normally.

The invention is not limited to any particular database script or programming language but any suitable language may be used as understood by the person skilled in the art. There are several possible graphical interfaces possible to use, including but not limited to, web interface or separate graphical windows related interface programmed for a client computational device with display means (e.g. computer monitor).

The invention may be realized in a single computational device, such as a microcomputer, embedded processor, workstation, FPGA (field programmable gate array), ASIC (application specific integrated circuit), server, or in a cluster of computational devices interacting with each other to provide enhanced computational power, speed, and/or storage capacity.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

1. A file management system, comprising:
a file system database with searchable entries;
a file manager communicating with said database; and
wherein said file manager comprises processing arrangement for organizing search results in a structure comprising two presentations; a first presentation for organizing selectable folders in a map with a tree structure with general levels of folders upstream and more detailed levels of folders downstream, and a second presentation for simultaneously organizing database entries associated with folders in downstream connection with a selected folder from said first presentation.

2. The file management system according to claim 1, wherein said arrangement for organizing database entries comprises organizing a summary of each entry found in said second presentation.

3. The file management system according to claim 1, wherein said arrangement for organizing database entries comprises organizing each entry found in its entirety.

4. The file management system according to claim 1, wherein said arrangement for organizing database entries comprises organizing only a title of each entry found in said second presentation.

5. The file management system according to claim 1, wherein said processing arrangement is arranged to apply a filter operating on database entries associated with said folders in downstream connection with said selected folder from said first presentation when organizing associated entries in said second presentation.

6. The file management system according to claim 5, wherein said filter is arranged to filter on at least one of name (e.g. alphabetically), date (e.g. of creation or last changed), type (e.g. documents, run files, system files), owner of file, ranked importance, size, location, number of users, creator of file, keyword, version, content, category, and number times file has been used.

7. The file management system according to claim 1, wherein said folders are grouped into comprehensive groupings comprising parts of or a whole map.

8. The file management system according to claim 1, wherein a plurality of maps of different criteria can be used for comparing quality aspects between said different criteria.

9. The file management system according to claim 8, wherein said comparing compares graphically at least one of size, complexity, or symmetry aspects.

10. The file management system according to claim 1, wherein said map with tree structure is a tree structure in one, two, or three dimensions.

11. The file management system according to claim 1, wherein said selected folder is centered in said first presentation when selected and the rest of said map is rearranged accordingly.

12. An instruction set stored on a storage medium providing search results from a file management system, comprising
an instruction set for sorting database entries in a tree structure of folders in a first presentation;
an instruction set for selecting a folder in said first presentation;
an instruction set for presenting in a second presentation database entries associated with folders in downstream connection with a selected folder from said first presentation.

13. The instruction set according to claim 12, further comprising an instruction set for filtering said database entries using filtering parameters.

14. The instruction set according to claim 13, wherein said filtering parameters are at least one of name (e.g. alphabetically), date (e.g. of creation or last changed), type (e.g. documents, run files, system files), owner of file, ranked importance, size, location, number of users, creator of file, keyword, version, content, category, and number times file has been used.

15. The instruction set according to claim 12, further comprising an instruction set for centering said selected folder in said first presentation when selected and an instruction set for rearranging the rest of said map accordingly.

16. A data management system, comprising:
a database with searchable entries;
a server communicating with said database; and
wherein said server comprises processing arrangement for organizing search results in a structure comprising two presentations; a first presentation for organizing selectable areas of interest in a map with a tree structure with general levels of interest upstream and more detailed levels of interest downstream, and a second presentation for simultaneously organizing database entries associated with areas of interest in downstream connection with a selected area of interest from said first presentation.

17. The data management system according to claim 16, wherein said organizing database entries comprises organizing a summary of each entry found in said second presentation.

18. The data management system according to claim 16, wherein said organizing database entries comprises organizing each entry found in its entirety.

19. The data management system according to claim 16, wherein said organizing database entries comprises organizing only a title of each entry found in said second presentation.

20. The data management system according to claim 16, wherein said server comprises a plurality of servers interconnected with each other directly or indirectly.

21. The data management system according to claim 16, wherein said processing arrangement is arranged to apply a filter operating on database entries associated with said areas of interest in downstream connection with said selected area of interest from said first presentation when organizing associated entries in said second presentation.

22. The data management system according to claim 21, wherein said filter is arranged to filter on at least one of quality, population, companies, geographical areas, type of equipment, cost, keywords, language, value, relevance, rating, track record, capacity for realization, customers, funding, size, educational level, number of employees, publications, certifications, branches, patents, and markets.

23. The data management system according to claim 16, wherein said areas of interest is grouped into comprehensive groupings comprising parts of or a whole map.

24. The data management system according to claim 16, wherein a plurality of maps of different criteria can be used for comparing quality aspects between said different criteria.

25. The data management system according to claim 24, wherein said comparing compares graphically at least one of size, complexity, or symmetry aspects.

26. The data management system according to claim 16, wherein said map with tree structure is a tree structure in one, two, or three dimensions.

27. The data management system according to claim 16, wherein said selected area of interest is centered in said first presentation when selected and the rest of said map is rearranged accordingly.

28. An instruction set stored on a storage medium providing search results from a data management system, comprising
an instruction set for sorting database entries in a tree structure of areas of interest in a first presentation;
an instruction set for selecting an area of interest in said first presentation;
an instruction set for presenting in a second presentation database entries associated with areas of interest in downstream connection with a selected area of interest from said first presentation.

29. The instruction set according to claim 28, further comprising an instruction set for filtering said database entries using filtering parameters.

30. The instruction set according to claim 29, wherein said filtering parameters are at least one of quality, population, companies, geographical areas, type of equipment, cost, keywords, language, value, relevance, rating, track record, capacity for realization, customers, funding, size, educational level, number of employees, publications, certifications, branches, patents, and markets.

31. The instruction set according to claim 28, further comprising an instruction set for centering said selected area of interest in said first presentation when selected and an instruction set for rearranging the rest of said map accordingly.

32. A network for data management, providing redundancy and security protection, comprising a plurality of processing units each comprising processing arrangement for organizing search results from a database in a structure comprising two presentations; a first presentation for organizing selectable areas of interest in a map with a tree structure with general levels of interest upstream and more detailed levels of interest downstream, and a second presentation for simultaneously organizing database entries associated with areas of interest in downstream connection with a selected area of interest from said first presentation.

33. A database object stored on a storage medium, comprising:
an information object;
a list of area of interest which said information object is relevant to; and
a list of applications which said information object is relevant to, wherein said database object is arranged so search results from said database is presented in a structure comprising two presentations; a first presentation for organizing selectable areas of interest in a map with a tree structure with general levels of interest upstream and more detailed levels of interest downstream, and a second presentation for simultaneously organizing said information objects associated with areas of interest in downstream connection with a selected area of interest from said first presentation.

34. A business method for providing decision making services within project management, wherein the data management system according to claim 16 is used for comparing regions with each other, the method comprises the steps of:
analyzing available resources within a plurality of regions with said data management system;
comparing said regions with each other using comparison criteria; and
providing a recommendation of best suited region for a specific project.

35. The business method according to claim 34, wherein said regions are geographical regions.

36. The business method according to claim 34, wherein said regions are departmental regions.

37. The business method according to claim 34, wherein said comparison criteria are at least one of quality, population, companies, geographical areas, type of equipment, cost, keywords, language, value, relevance, rating, track record, capacity for realization, customers, funding, size, educational level, number of employees, publications, certifications, branches, patents, and markets.
